(19) United States
(12) Patent Application Publication
(10) Pub. No.: US 2019/0258270 A1
(43) Pub. Date: Aug. 22, 2019

(54) TRAVELING CONTROL SYSTEM FOR AUTONOMOUS TRAVELING VEHICLES, SERVER APPARATUS, AND AUTONOMOUS TRAVELING VEHICLE

(71) Applicants: Toyota Jidosha Kabushiki Kaisha, Toyota-shi Aichi-ken (JP); Denso Corporation, Kariya-City (JP)

(72) Inventors: Naoki Yamamuro, Nagoya-shi Aichi-ken (JP); Shinichi Adachi, Kariya-shi Aichi-ken (JP); Ryo Hattori, Kariya-shi Aichi-ken (JP); Taichi Amakasu, Toyota-shi Aichi-ken (JP); Keigo Hiruma, Kariya-shi Aichi-ken (JP)

(21) Appl. No.: 16/277,013

(22) Filed: Feb. 15, 2019

(30) Foreign Application Priority Data
Feb. 16, 2018 (JP) 2018-026147

(51) Int. Cl. G05D 1/02; G05D 1/00

(52) U.S. Cl. CPC G05D 1/0293; G05D 2201/0213; G05D 1/0088

(57) ABSTRACT

The present disclosure resides in a traveling control system for autonomous traveling vehicles for controlling the plurality of autonomous traveling vehicles which perform autonomous traveling in accordance with predetermined operation commands, the traveling control system comprising a controller which is configured to set priorities among the plurality of autonomous traveling vehicles, and to control traveling of the plurality of autonomous traveling vehicles so that the autonomous traveling vehicle having the priority set to be high travels preferentially as compared with the autonomous traveling vehicle having the priority set to be low, if the plurality of autonomous traveling vehicles travel on an identical lane in a mixed manner.

### CROSS REFERENCE TO RELATED APPLICATION

This application claims the benefit of Japanese Patent Application No. 2018-026147, filed on Feb. 16, 2018, which is hereby incorporated by reference herein in its entirety.

### BACKGROUND

### Technical Field

The present disclosure relates to a traveling control system for autonomous traveling vehicles, a server apparatus, and an autonomous traveling vehicle.

### Description of Related Art

In recent years, the development is advanced for a vehicle capable of autonomous traveling (hereinafter referred to as “autonomous traveling vehicle” in some cases). As for the technique for controlling the operation of the autonomous traveling vehicle as described above, for example, Japanese Patent Application Laid-Open No. 11-134600 discloses a technique in which a plurality of autonomous traveling vehicles are allowed to travel at a constant velocity while maintaining distances between the autonomous traveling vehicles (inter-vehicle distance or following distance), i.e., the plurality of autonomous traveling vehicles are allowed to perform the so-called platoon traveling or row running, when the plurality of autonomous traveling vehicles travel on an identical lane.

### SUMMARY

In the meantime, assuming that the needs for the autonomous traveling vehicle are diversified, it is also conceived that a plurality of autonomous traveling vehicles, which have different needs, travel on an identical lane in a mixed manner. In such a situation, it is necessary that the plurality of autonomous traveling vehicles should travel efficiently.

The present disclosure has been made taking the request as described above into consideration, an object of which is to provide a technique that makes it possible to allow a plurality of autonomous traveling vehicles to travel efficiently when the plurality of autonomous traveling vehicles travel on an identical lane in a mixed manner.

In the present disclosure, in order to solve the problem as described above, there is provided a traveling control system for autonomous traveling vehicles which perform autonomous traveling in accordance with predetermined operation commands, wherein priorities are set among the plurality of autonomous traveling vehicles, and thus the autonomous traveling vehicle having the high priority is allowed to travel preferentially as compared with the autonomous traveling vehicle having the low priority, when the plurality of autonomous traveling vehicles travel on an identical lane.

In particular, the present disclosure resides in a traveling control system for autonomous traveling vehicles for controlling the plurality of autonomous traveling vehicles which perform autonomous traveling in accordance with predetermined operation commands. Then, the traveling control system may include a controller comprising at least one processor. The controller may be configured to: set priorities among the plurality of autonomous traveling vehicles; and control traveling of the plurality of autonomous traveling vehicles so that the autonomous traveling vehicle having the priority set to be high travels preferentially as compared with the autonomous traveling vehicle having the priority set to be low, if the plurality of autonomous traveling vehicles travel on an identical lane in a mixed manner.

If the plurality of autonomous traveling vehicles travel on the identical lane in the mixed manner, there is a possibility that the needs may differ in relation to each of the individual autonomous traveling vehicles. As for the “needs” referred to herein, those assumed are, for example, the needs in which the cost (fare or carriage) is regarded as important as compared with the early arrival at the destination point or the smooth traveling to the destination point (hereinafter generally referred to as “traveling quality” in some cases), and the needs in which the traveling quality is regarded as important as compared with the fare or carriage. Then, when the plurality of autonomous traveling vehicles travel on the identical lane in the mixed manner, if the needs of the autonomous traveling vehicles are different from each other, then there is a possibility that it may be impossible for the respective autonomous traveling vehicles to perform the traveling adequate for the needs.

On the contrary, according to the traveling control system for the autonomous traveling vehicles according to the present disclosure, when the plurality of autonomous traveling vehicles travel on the identical lane in the mixed manner, the traveling of the plurality of autonomous traveling vehicles is controlled so that the autonomous traveling vehicle having the priority set to be high by the controller travels preferentially as compared with the autonomous traveling vehicle having the priority set to be low by the controller. In this context, the phrase that the autonomous traveling vehicle having the high priority travels preferentially means, for example, that the course change (lane change), the change of the traveling speed or the like of the autonomous traveling vehicle having the high priority, which would be otherwise caused by the presence of the autonomous traveling vehicle having the low priority on the course of the autonomous traveling vehicle having the high priority, is suppressed, in other words, the other autonomous traveling vehicle having the low priority is departed from the course of the autonomous traveling vehicle having the high priority (the former gives way to the latter). Accordingly, when the plurality of autonomous traveling vehicles travel on the identical lane in the mixed manner, such a situation is suppressed that the autonomous traveling vehicle having the low priority disturbs the smooth traveling of the autonomous traveling vehicle having the high priority. As a result, the respective autonomous traveling vehicles easily perform the traveling adequate for the needs.

In this context, the controller may set the high priority for the autonomous traveling vehicle in which a billing charge is high for a user as compared with the autonomous traveling vehicle in which the billing charge is low for the user. The “billing charge” referred to herein is the charge which is determined such that the higher the traveling quality required for the autonomous traveling vehicle is, the more expensive the charge is. In other words, the billing charge is determined to be more expensive for the user who requests the earlier arrival at the destination point and/or the smoother traveling to the destination point. If the priority is set on the basis of the billing charge as described above, the autonomous traveling vehicle, in which the billing charge is high for the user, can travel preferentially as compared with the autonomous traveling vehicle in which the billing charge is low for the user. Accordingly, such a situation is suppressed that the autonomous traveling vehicle in which the billing charge is low for the user disturbs the smooth traveling of the autonomous traveling vehicle in which the billing charge is high for the user. As a result, the respective autonomous traveling vehicles easily realize the traveling qualities corresponding to the needs of the user.

Further, the controller may set the high priority for the autonomous traveling vehicle in which a traveling speed is high as compared with the autonomous traveling vehicle in which the traveling speed is low. Accordingly, when the plurality of autonomous traveling vehicles having different traveling speeds travel on the identical lane, the autonomous traveling vehicle having the high traveling speed can travel preferentially as compared with the autonomous traveling vehicle having the low traveling speed. Accordingly, such a situation is suppressed that the autonomous traveling vehicle having the low traveling speed disturbs the smooth traveling of the autonomous traveling vehicle having the high traveling speed. As a result, when the plurality of autonomous traveling vehicles having the different traveling speeds travel on the identical lane in the mixed manner, the autonomous traveling vehicles can be allowed to travel efficiently.

In another aspect, the present disclosure can be also grasped as a server apparatus for controlling a plurality of autonomous traveling vehicles which perform autonomous traveling in accordance with predetermined operation commands. In this case, the server apparatus according to the present disclosure may include a controller comprising at least one processor. The controller may be configured to set priorities among the plurality of autonomous traveling vehicles; and provide the operation commands to the plurality of autonomous traveling vehicles so that the autonomous traveling vehicle having the priority set to be high travels preferentially as compared with the autonomous traveling vehicle having the priority set to be low, if the plurality of autonomous traveling vehicles traveling on an identical lane are detected.

According to the server apparatus described above, when the plurality of autonomous traveling vehicles traveling on the identical lane are detected, the operation commands are provided with respect to the plurality of autonomous traveling vehicles so that the autonomous traveling vehicle having the priority set to be high by the controller travels preferentially as compared with the autonomous traveling vehicle having the priority set to be low by the controller. In this case, the plurality of autonomous traveling vehicles travel in accordance with the operation commands provided from the server apparatus. Accordingly, when the plurality of autonomous traveling vehicles travel on the identical lane in a mixed manner, such a situation is suppressed that the autonomous traveling vehicle having the low priority disturbs the smooth traveling of the autonomous traveling vehicle having the high priority. As a result, when the plurality of autonomous traveling vehicles travel on the identical lane in the mixed manner, it is possible to allow the plurality of autonomous traveling vehicles to travel efficiently.

In still another aspect, the present disclosure can be also grasped as an autonomous traveling vehicle which performs autonomous traveling in accordance with a predetermined operation command. In this case, the autonomous traveling vehicle may include a controller comprising at least one processor. The controller may be configured to detect an other autonomous traveling vehicle which follows the subject vehicle on the same lane as that of the subject vehicle; acquire an information concerning a priority of the other autonomous traveling vehicle by making inter-vehicle communication with the other autonomous traveling vehicle, if the other autonomous traveling vehicle is detected; and control traveling of the subject vehicle so that the other autonomous traveling vehicle travels preferentially as compared with the subject vehicle, if the acquired priority of the other autonomous traveling vehicle is higher than a priority of the subject vehicle.

According to the autonomous traveling vehicle described above, when the other autonomous traveling vehicle, which follows the subject vehicle, is detected on the same lane as that of the subject vehicle, the information concerning the priority of the following other autonomous traveling vehicle is acquired by making the inter-vehicle communication between the subject vehicle and the following other autonomous traveling vehicle. Then, if the priority of the following other autonomous traveling vehicle acquired as described above is higher than the priority of the subject vehicle, the traveling of the subject vehicle is controlled so that the following other autonomous traveling vehicle travels preferentially as compared with the subject vehicle. Accordingly, such a situation is suppressed that the subject vehicle disturbs the smooth traveling of the following other autonomous traveling vehicle. As a result, when the plurality of autonomous traveling vehicles travel on the identical lane, it is possible to allow the plurality of autonomous traveling vehicles to travel efficiently.

According to the present disclosure, when the plurality of autonomous traveling vehicles travel on the identical lane in the mixed manner, it is possible to allow the plurality of autonomous traveling vehicles to travel efficiently.

### BRIEF DESCRIPTION OF DRAWINGS

FIG. 1 indicates an outline of a moving body system to which the present disclosure is applied.

FIG. 2 indicates a block diagram schematically illustrating exemplary constitutive components possessed by the moving body system.

FIG. 3 indicates a first example in which a preceding vehicle having a low priority gives way to a following vehicle having a high priority.

FIG. 4 indicates a second example in which a preceding vehicle having a low priority gives way to a following vehicle having a high priority.

FIG. 5 exemplifies the table configuration of vehicle information stored in a storage unit of a server apparatus.

FIG. 6 indicates a flow diagram illustrating the flow of the data and the process performed between the respective constitutive components of the moving body system according to the embodiment of the present disclosure.

### DETAILED DESCRIPTION

An explanation will be made below on the basis of the drawings about specified embodiments of the present disclosure. For example, the dimension or size, the material, the shape, and the relative arrangement of constitutive parts or components described in the embodiments of the present disclosure are not intended to limit the technical scope of the present disclosure only thereto unless specifically noted.

### System Outline

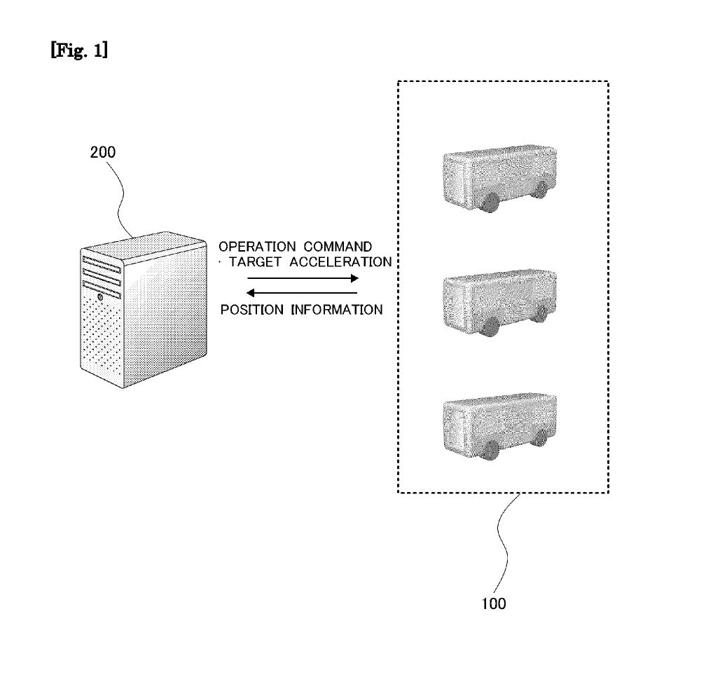

In this embodiment, an example will be described, in which the present disclosure is applied to a moving body system including a plurality of moving bodes (autonomous traveling vehicles) capable of performing the autonomous traveling. FIG. 1 indicates an outline of a moving body system according to this embodiment. The moving body system indicated in FIG. 1 is configured to include a plurality of autonomous traveling vehicles 100 which perform the autonomous traveling in accordance with provided operation commands, and a server apparatus 200 which issues the operation commands to the respective autonomous traveling vehicles 100. The autonomous traveling vehicle 100 is an automatic driving vehicle which provides predetermined service. On the other hand, the server apparatus 200 is an apparatus which manages and controls the operations of the respective autonomous traveling vehicles 100.

Each of the autonomous traveling vehicles 100 is a multipurpose moving body in which the specification such as the inner and outer package or the like can be easily changed depending on the use (way of use), the vehicle being capable of performing the autonomous traveling on the road. The autonomous traveling vehicle 100 is, for example, a shared bus which carries a plurality of customers along with a predetermined route, an on-demand taxi which is operated along with a route corresponding to a request from a customer, a cargo transport vehicle which transports cargoes along with a predetermined route, or a staying type passenger transport vehicle which is operated along with a route corresponding to a request from a customer (for example, a vehicle which is installed with hotel facilities or workspace in the room). Note that it is not necessarily indispensable that the autonomous traveling vehicle 100 of this embodiment should be a vehicle on which any person other than passengers does not get. For example, the customer service personnel to perform the customer service for passengers, the security personnel to secure the safety of the autonomous traveling vehicle 100, or the collection and delivery personnel to load and unload cargoes may be accompanied. Further, it is also allowable that the autonomous traveling vehicle 100 is not necessarily a vehicle which can perform the complete autonomous traveling. The autonomous traveling vehicle 100 may be a vehicle for which the driving personnel performs the driving or the assistance for the driving depending on circumstances.

The server apparatus 200 is an apparatus which commands the respective autonomous traveling vehicles 100 to perform the operation. For example, when the autonomous traveling vehicle 100 is an on-demand taxi, then a request from a user is accepted, and the point for the vehicle to go to pickup the user and the destination point are acquired. After that, an operation command of “transport the person from the departure point to the destination point” is transmitted to the autonomous traveling vehicle 100 having the equipment of the taxi, of the autonomous traveling vehicles traveling in the neighborhood. Accordingly, the autonomous traveling vehicle 100, which receives the operation command from the server apparatus 200, can travel along the route based on the operation command.

Note that the operation command not necessarily commands the autonomous traveling vehicle 100 to perform the traveling to connect the departure point and the destination point. For example, the operation command may be “travel to predetermined point to collect and/or deliver cargo” or “stop for a predetermined time at a sightseeing spot existing in the course of predetermined route”. In this way, the operation command may include the action other than the traveling to be performed by the autonomous traveling vehicle 100.

Further, the server apparatus 200 also has such a function that when a plurality of autonomous traveling vehicles 100 travel on an identical lane in a mixed manner, the commands, which are provided in order to allow the plurality of autonomous traveling vehicles to travel efficiently, are transmitted to the plurality of autonomous traveling vehicles 100. Specifically, the server apparatus 200 sets the priorities among the plurality of autonomous traveling vehicles 100. Then, the server apparatus 200 transmits, to the plurality of autonomous traveling vehicles, the commands which are provided in order that the autonomous traveling vehicle 100 having the high priority travels preferentially as compared with the autonomous traveling vehicle 100 having the low priority.

Note that it is not necessarily indispensable that the server apparatus 200 is composed of one apparatus. The server apparatus 200 may be composed of a plurality of apparatuses each of which is installed in every region.

### System Configuration

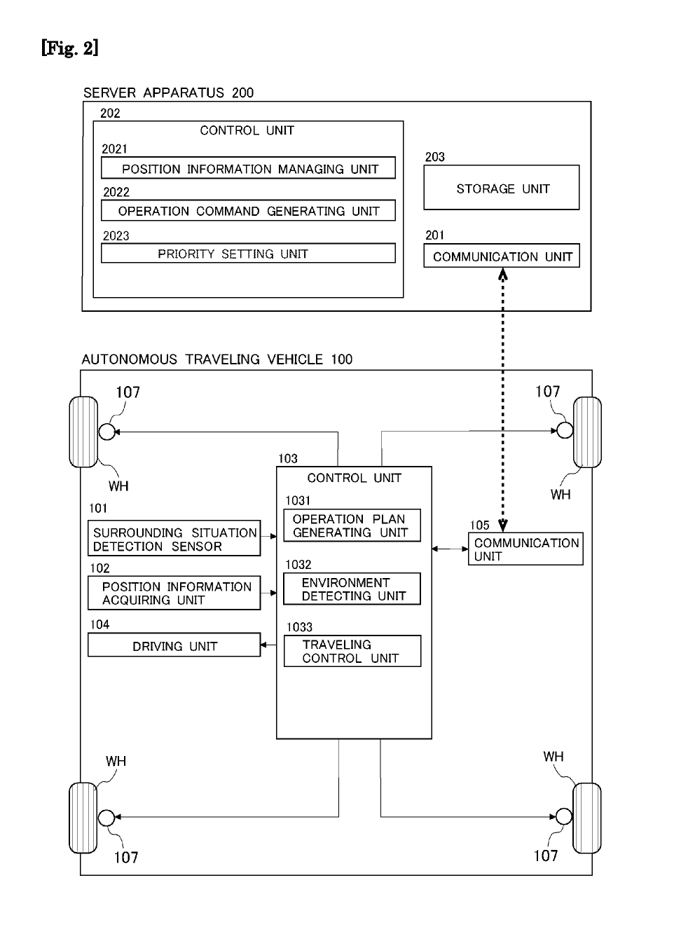

Next, an explanation will be made in detail about the constitutive components of the movement system according to this embodiment. FIG. 2 indicates a block diagram schematically illustrating exemplary configuration of the autonomous traveling vehicle 100 and the server apparatus 200 indicated in FIG. 1. Note that a plurality of autonomous traveling vehicles 100 may be provided.

As described above, the autonomous traveling vehicle 100 is the vehicle which travels in accordance with the operation command acquired from the server apparatus 200. The autonomous traveling vehicle 100 as described above is configured to include, for example, a surrounding situation detection sensor 101, a position information acquiring unit 102, a control unit 103, a driving unit 104, and a communication unit 105. The autonomous traveling vehicle 100 of this embodiment is an electric automobile which is driven by using an electric motor as a motor. Note that the motor of the autonomous traveling vehicle 100 is not limited to the electric motor, which may be an internal combustion engine or a hybrid mechanism composed of an internal combustion engine and an electric motor.

The surrounding situation detection sensor 101 senses around the vehicle. Typically, the surrounding situation detection sensor 101 is configured to include, for example, a stereo camera, a laser scanner, LIDAR, and a radar. The information, which is acquired by the surrounding situation detection sensor 101, is delivered to the control unit 103.

The position information acquiring unit 102 acquires the present position of the autonomous traveling vehicle 100. Typically, the position information acquiring unit 102 is configured to include, for example, a GPS receiver. Note that the position information acquiring unit 102 acquires the present position of the autonomous traveling vehicle 100 at a predetermined cycle and delivers the information concerning the acquired present position to the control unit 103. In accordance therewith, every time when the control unit 103 accepts the position information from the position information acquiring unit 102, the control unit 103 transmits the position information to the server apparatus 200. In other words, the position information of the autonomous traveling vehicle 100 is transmitted at a predetermined cycle from the autonomous traveling vehicle 100 to the server apparatus 200. Accordingly, the server apparatus 200 can grasp the present positions (current positions) of the respective autonomous traveling vehicles 100.

The control unit 103 is a computer which controls the operation of the autonomous traveling vehicle 100 on the basis of the information acquired from the surrounding situation detection sensor 101 and which controls the traveling state of the autonomous traveling vehicle 100 in accordance with the command from the server apparatus 200. The control unit 103 is configured, for example, by a microcomputer. The control unit 103 of this embodiment has, as functional modules, an operation plan generating unit 1031, an environment detecting unit 1032, and a traveling control unit 1033. The respective functional modules may be realized by executing programs stored in storage such as ROM (Read Only Memory) or the like by CPU (Central Processing Unit) (any of them is not indicated).

The operation plan generating unit 1031 acquires the operation command from the server apparatus 200 to generate the operation plan of the subject vehicle. In this embodiment, the operation plan is the data that prescribes the route along which the autonomous traveling vehicle 100 travels and the process which is to be performed by the autonomous traveling vehicle 100 in a part of or all of the route. For example, the followings are exemplified as examples of the data included in the operation plan.

(1) Data in which route (scheduled traveling route) scheduled for subject vehicle to travel therealong is represented by set of road links

The “scheduled traveling route” referred to herein may be generated by the operation plan generating unit 1031, for example, on the basis of the departure point and the destination point given by the operation command sent from the server apparatus 200 while making reference to the map data stored in the storage apparatus carried on the autonomous traveling vehicle 100. Alternatively, the “scheduled traveling route” may be generated by utilizing any external service, or it may be provided from the server apparatus 200. Note that in the configuration in which the “scheduled traveling route” is generated by utilizing the external service or the operation plan generating unit 1031 of the autonomous traveling vehicle 100, it is assumed that the generated “scheduled traveling route” is transmitted to the server apparatus 200 by the communication unit 105 described later on.

(2) Data which represents process to be performed by subject vehicle at arbitrary point on scheduled traveling route

The process to be performed by the subject vehicle includes, for example, “allow passengers to get on/off”, “load/unload cargoes”, and “stop for a predetermined period for passenger's sightseeing”. However, there is no limitation thereto.

The environment detecting unit 1032 detects the environment around the vehicle on the basis of the data acquired by the surrounding situation detection sensor 101. The object of the detection is, for example, the number and the position of the lane(s), the number and the position of the vehicle(s) existing around the subject vehicle, the number and the position of the obstacle(s) (for example, pedestrian(s), bicycle(s), structure(s), and building(s)) existing around the subject vehicle, the structure of the road, and the road sign. However, there is no limitation thereto. The detection target may be anyone provided that the object is required to perform the autonomous traveling. Further, the environment detecting unit 1032 may perform the tracking for the detected object. For example, the relative velocity of the object may be determined from the difference between the coordinates of the object detected one step before and the present coordinates of the object.

The traveling control unit 1033 controls the traveling of the subject vehicle on the basis of the operation plan generated by the operation plan generating unit 1031, the environment data generated by the environment detecting unit 1032, and the position information of the subject vehicle acquired by the position information acquiring unit 102. For example, the traveling control unit 1033 allows the subject vehicle to travel along the scheduled traveling route generated by the operation plan generating unit 1031, and the traveling control unit 1033 allows the subject vehicle to travel so that any obstacle does not enter a predetermined safe area provided around the subject vehicle as the center. Note that as for the method for allowing the subject vehicle to perform the autonomous traveling, it is possible to adopt any known method. Further, the traveling control unit 1033 also has such a function that the traveling the autonomous traveling vehicle 100 is controlled in accordance with the command supplied from the server apparatus 200.

The driving unit 104 is the means for allowing the autonomous traveling vehicle 100 to travel on the basis of the command generated by the traveling control unit 1033. The driving unit 104 is configured to include, for example, a motor (for example, an internal combustion engine, an electric motor, or a hybrid mechanism of an internal combustion engine and an electric motor), a braking apparatus, and a steering arrangement (steering gear).

The communication unit 105 is the communication means for connecting the autonomous traveling vehicle 100 to the network. In this embodiment, the communication can be performed with any other apparatus (for example, the server apparatus 200) via the network by utilizing the mobile communication service such as 3G (3rd Generation), LTE (Long Term Evolution) or the like. Note that the communication unit 105 may further comprise any communication means for performing the inter-vehicle communication with respect to any other autonomous traveling vehicle 100. In this embodiment, for example, the communication unit 105 transmits, to the server apparatus 200, the present position information of the subject vehicle acquired by the position information acquiring unit 102 and the operation plan (scheduled traveling route) generated by the operation plan generating unit 1031.

Next, the server apparatus 200 will be explained. The server apparatus 200 is the apparatus which manages the traveling positions of the plurality of autonomous traveling vehicles 100 and which transmits the operation commands. The server apparatus 200 as described above is configured to have a communication unit 201, a control unit 202, and a storage unit 203. The communication unit 201 is a communication interface for performing the communication with the autonomous traveling vehicle 100 via the network in the same manner as the communication unit 105 of the autonomous traveling vehicle 100.

The control unit 202 is the means for controlling the server apparatus 200. The control unit 202 is configured, for example, by CPU. The control unit 202 of this embodiment has, as functional modules, a position information managing unit 2021, an operation command generating unit 2022, and a priority setting unit 2023. These functional modules may be realized by executing programs stored in the storage means such as ROM or the like by CPU (any of them is not indicated).

The position information managing unit 2021 manages the present positions of the autonomous traveling vehicles 100 under the management of the server apparatus 200. Specifically, the position information managing unit 2021 receives the position information from the plurality of autonomous traveling vehicles 100 under the management of the server apparatus 200 at every predetermined cycle, and the position information managing unit 2021 stores the present position information in the storage unit 203 as described later on while being correlated with the date and time.

The operation command generating unit 2022 determines the autonomous traveling vehicle 100 to be dispatched when a vehicle allocation request for the autonomous traveling vehicle 100 is received from the outside, and the operation command generating unit 2022 generates the operation command corresponding to the vehicle allocation request. The vehicle allocation request includes, for example, the followings. However, it is also allowable to provide any other request.

(1) Transport request for cargoes and passengers

This request is to perform the transport of cargoes and passengers by designating the departure point and the destination point, or the traveling route.

(2) Dispatch request for autonomous traveling vehicle having specified function in combination

This request is to ask the dispatch of the autonomous traveling vehicle 100 having the function of, for example, the lodging facilities for passengers (hotel) or the workspace for passengers (for example, private office or business office). As for the dispatch destination, either a single point is available, or a plurality of points are available. If a plurality of dispatch destinations are designated, it is also allowable to provide the service at the plurality of points respectively.

The vehicle allocation request as described above also includes the needs capable of being selected by the user depending on the charge. The needs referred to herein are, for example, the needs in which the cost (fare or carriage) is regarded as important as compared with the early arrival at the destination point or the smooth traveling until the destination point (traveling quality), and the needs in which the traveling quality is regarded as important as compared with the fare or carriage.

Further, the vehicle allocation request as described above is acquired from the user or customer, for example, via the internet. Note that it is not necessarily indispensable that the transmission source of the vehicle allocation request should be any general user. The transmission source of the vehicle allocation request may be, for example, an entrepreneur who operates the autonomous traveling vehicle 100. The autonomous traveling vehicle 100, which is the transmission destination of the operation command, is determined depending on, for example, the present position information of each of the autonomous traveling vehicles 100 acquired by the position information managing unit 2021 and the specification of each of the autonomous traveling vehicles 100 (for what way of use the vehicle has its interior/exterior equipment) previously grasped by the server apparatus 200. Then, if the autonomous traveling vehicle 100, which is the transmission destination of the operation command, is determined, the operation command, which is generated by the operation command generating unit 2022, is transmitted to the autonomous traveling vehicle 100 by the aid of communication unit 201.

Note that the operation command generating unit 2022 of this embodiment also has such a function that if a plurality of autonomous traveling vehicles 100, which travel on an identical lane in a mixed manner, are detected from the position information of the respective autonomous traveling vehicles 100 received by the position information managing unit 2021, the commands are generated in order to allow the plurality of autonomous traveling vehicles 100 to travel efficiently. The commands are generated on the basis of the priorities of the respective autonomous traveling vehicles 100 set by the priority setting unit 2023 as described later on. That is, the commands are generated in order that the autonomous traveling vehicle 100 having the high priority travels preferentially as compared with the autonomous traveling vehicle 100 having the low priority.

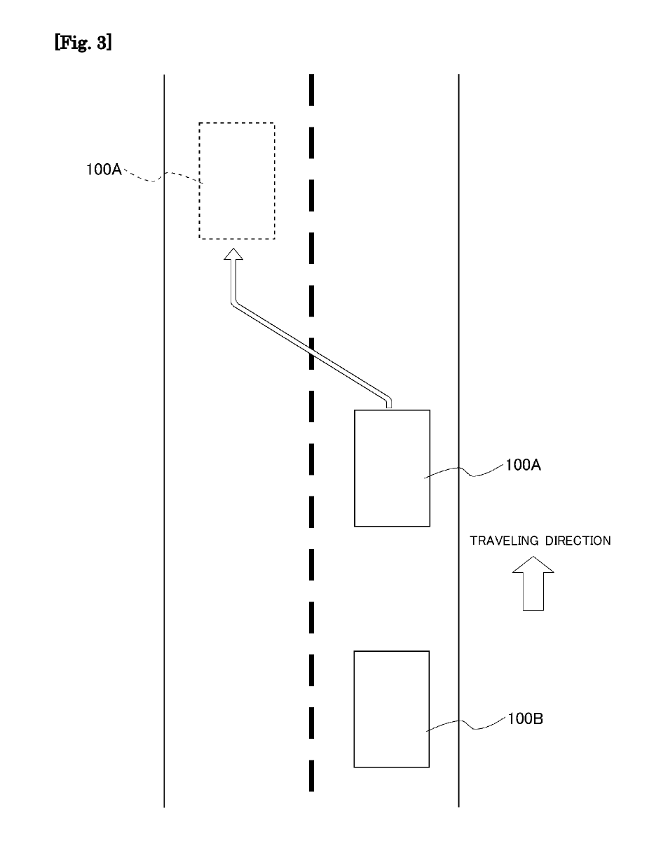

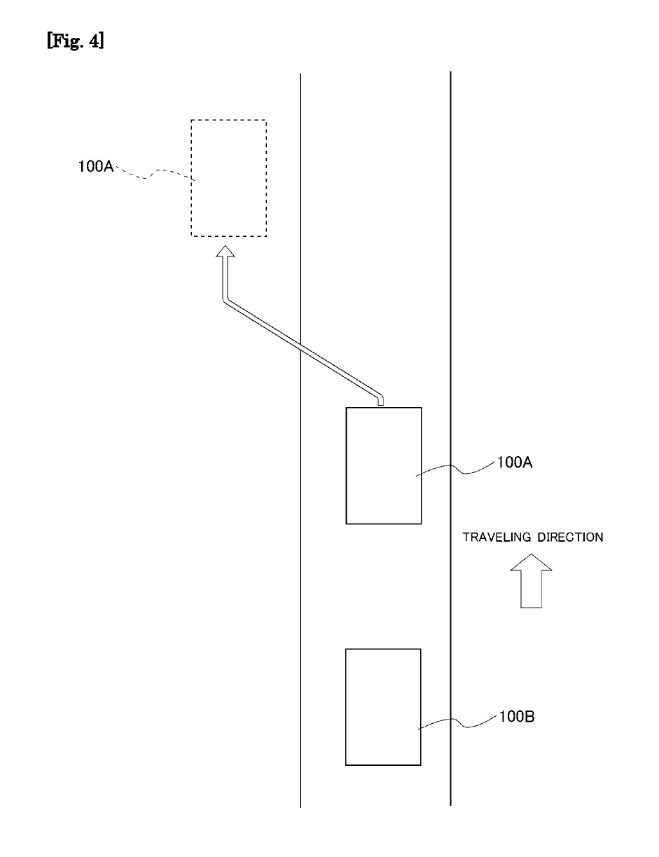

In this case, for example, if the autonomous traveling vehicle 100 having the low priority travels while preceding the autonomous traveling vehicle 100 having the high priority, the operation command generating unit 2022 generates the command to allow the autonomous traveling vehicle 100 having the low priority to depart from the course of the autonomous traveling vehicle 100 having the high priority. The “departure (depart)” referred to herein includes, for example, a mode in which the preceding first autonomous traveling vehicle 100A is subjected to the lane change to the lane different from the cruising lane of the following second autonomous traveling vehicle 100B as indicated in FIG. 3, and a mode in which the preceding first autonomous traveling vehicle 100A is putted aside to the road shoulder so that the preceding first autonomous traveling vehicle 100A temporarily stops as indicated in FIG. 4. Then, as for the autonomous traveling vehicle 100 which receives the command as described above, the traveling control unit 1033 follows the command so that the autonomous traveling vehicle 100 is subjected to the lane change, or the autonomous traveling vehicle 100 is putted aside to the road shoulder to temporarily stop. Accordingly, when the plurality of autonomous traveling vehicles 100 travel on the identical lane in the mixed manner, the autonomous traveling vehicle 100 having the high priority can be allowed to travel preferentially as compared with the autonomous traveling vehicle 100 having the low priority. As a result, it is possible to allow the plurality of autonomous traveling vehicles 100 to travel efficiently.

The priority setting unit 2023 sets the priorities among the plurality of autonomous traveling vehicles 100 when the plurality of autonomous traveling vehicles 100 travel on the identical lane in the mixed manner. In this embodiment, the priority setting unit 2023 sets the priorities of the respective autonomous traveling vehicles 100 on the basis of the billing charges of the respective autonomous traveling vehicles 100 with respect to the user. The “billing charge” referred to herein is the charge for which the user is subjected to billing depending on the needs of the user. As described above, the needs of the user are, for example, the needs in which the fare or carriage is regarded as important as compared with the traveling quality, and the needs in which the traveling quality is regarded as important as compared with the fare or carriage. Then, if the user regards the traveling quality as important as compared with the fare or carriage, the billing charge is set to be high as compared with if the user regards the fare or carriage as important as compared with the traveling quality. In this case, it is also allowable that the higher the traveling quality required by the user is, the higher the billing charge to be set is. When the billing charge is set as described above, the priority setting unit 2023 acquires the billing charges of the respective autonomous traveling vehicles 100 with respect to the user by making reference to the vehicle information table in the storage unit 203 as described later on. Then, the priority setting unit 2023 sets the priority to be high for the autonomous traveling vehicle 100 in which the billing charge is high with respect to the user as compared with the autonomous traveling vehicle 100 in which the billing charge is low with respect to the user. Accordingly, when the plurality of autonomous traveling vehicles 100 travel on the identical lane in the mixed manner, the autonomous traveling vehicle 100 in which the billing charge is high with respect to the user (autonomous traveling vehicle 100 in which the traveling quality is regarded as important as compared with the fare or carriage) can travel preferentially as compared with the autonomous traveling vehicle 100 in which the billing charge is low with respect to the user (autonomous traveling vehicle 100 in which the fare or carriage is regarded as important as compared with the traveling quality).

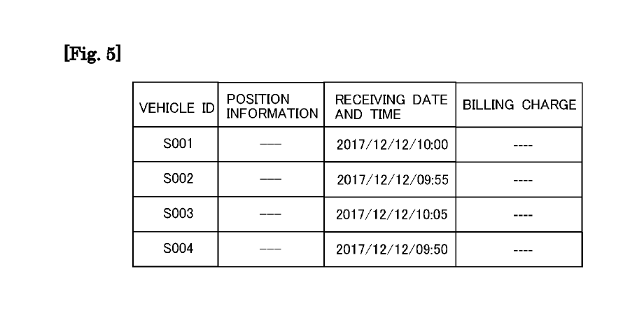

The storage unit 203 is the means for storing the information. The storage unit 203 is configured by a storage medium such as a magnetic disk, a flash memory or the like. The vehicle information concerning the individual autonomous traveling vehicle 100 is stored in the storage unit 203 of this embodiment in which the vehicle information is linked to the identification information of the individual autonomous traveling vehicle 100. An explanation will now be made on the basis of FIG. 5 about exemplary configuration of the vehicle information stored in the storage unit 203. FIG. 5 indicates the table configuration of the vehicle information. The vehicle information table indicated in FIG. 5 has respective fields of, for example, the vehicle ID, the position information, the date and time of the receiving, and the billing charge. The vehicle identification information (vehicle ID), which is provided to identify the individual autonomous traveling vehicle 100, is inputted into the vehicle ID field. The present position information, which is received by the position information managing unit 2021 from the individual autonomous traveling vehicle 100, is inputted into the position information field. The present position information, which is inputted into the position information field, may be, for example, the information which indicates the address of the place at which the autonomous traveling vehicle 100 is positioned, or the information which indicates the coordinates (latitude, longitude) on a map of the place at which the autonomous traveling vehicle 100 is positioned. The date and time, at which the present position information inputted into the position information field described above is received by the position information managing unit 2021, is inputted into the receiving date and time field. Note that it is assumed that the information, which is inputted into the position information field and the receiving date and time field, is updated every time when the position information managing unit 2021 receives the position information from each of the autonomous traveling vehicles 100 (in the predetermined cycle described above). Then, the billing charge of the individual autonomous traveling vehicle 100 with respect to the user is inputted into the billing charge field. Note that the information, which is inputted into the billing charge field, is inputted in accordance with the needs of the user included in the vehicle allocation request described above.

### Operation Action of Autonomous Traveling Vehicle

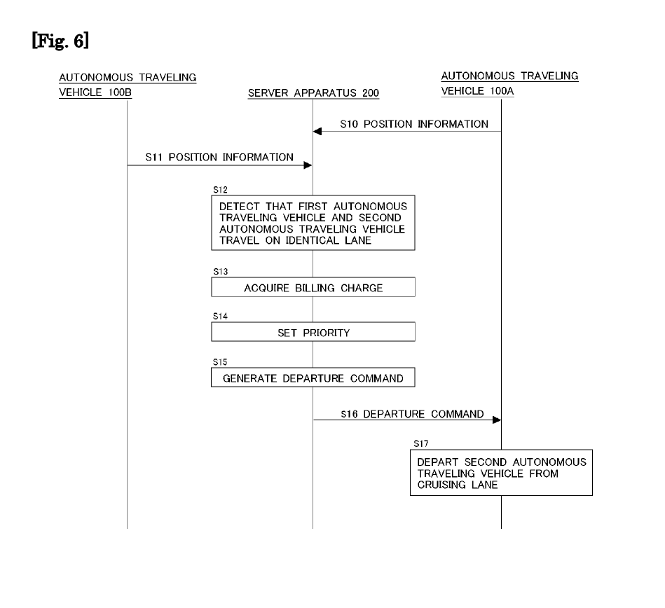

An explanation will now be made about the processes performed by the respective constitutive components described above. FIG. 6 explains the data flow transmitted/received between the server apparatus 200 and the plurality of autonomous traveling vehicles 100 when the plurality of autonomous traveling vehicles 100 travel on the identical lane in the mixed manner. This exemplary embodiment will be explained as exemplified by a case in which the first autonomous traveling vehicle 100A and the second autonomous traveling vehicle 100B, which have different priorities, travel on the identical lane. Note that it is assumed that the first autonomous traveling vehicle 100A travels while preceding the second autonomous traveling vehicle 100B at the point in time at which the server apparatus 200 detects that the first autonomous traveling vehicle 100A and the second autonomous traveling vehicle 100B travel on the identical lane.

As described above, each of the autonomous traveling vehicles 100A, 100B informs the server apparatus 200 of the present position information at a predetermined cycle. In this procedure, the signal, which is transmitted from the autonomous traveling vehicle 100 to the server apparatus 200, includes the identification information (vehicle ID) of the autonomous traveling vehicle 100 in addition to the present position information of the autonomous traveling vehicle 100. If the present position information and the vehicle ID transmitted from the autonomous traveling vehicle 100 is received by the communication unit 201 of the server apparatus 200 (Steps S10, S11), the position information managing unit 2021 accesses the vehicle information stored in the storage unit 203 to update information of the position information field and the receiving date and time field of the vehicle information table corresponding to the vehicle ID.

If the information of the position information field and the receiving date and time field of the vehicle information table is updated for each of the first autonomous traveling vehicle 100A and the second autonomous traveling vehicle 100B, the operation command generating unit 2022 makes reference to the position information field of the vehicle information table corresponding to each of the plurality of autonomous traveling vehicles 100 under the control of the server apparatus 200 in Step S12 to thereby detect the plurality of autonomous traveling vehicles 100 traveling on the identical lane (first autonomous traveling vehicle 100A and second autonomous traveling vehicle 100B in this embodiment).

If the first autonomous traveling vehicle 100A and the second autonomous traveling vehicle 100B, which travel on the identical lane, are detected by the operation command generating unit 2022, the priority setting unit 2023 acquires the billing charges of the respective autonomous traveling vehicles 100A, 100B with respect to the users by making reference to the vehicle information table of the first autonomous traveling vehicle 100A and the vehicle information table of the second autonomous traveling vehicle 100B stored in the storage unit 203 in Step S13.

In Step S14, the priority setting unit 2023 sets the priorities between the first autonomous traveling vehicle 100A and the second autonomous traveling vehicle 100B by comparing the billing charge of the first autonomous traveling vehicle 100A with respect to the user with the billing charge of the second autonomous traveling vehicle 100B with respect to the user. In this embodiment, it is assumed that the billing charge of the second autonomous traveling vehicle 100B with respect to the user is higher than the billing charge of the first autonomous traveling vehicle 100A with respect to the user. Accordingly, the priority of the second autonomous traveling vehicle 100B is set to be higher than that of the first autonomous traveling vehicle 100A.

If the priorities between the first autonomous traveling vehicle 100A and the second autonomous traveling vehicle 100B are set by the priority setting unit 2023, the operation command generating unit 2022 generates the commands in Step S15 in order that the second autonomous traveling vehicle 100B travels preferentially as compared with the first autonomous traveling vehicle 100A. In this embodiment, the first autonomous traveling vehicle 100A travels while preceding the second autonomous traveling vehicle 100B. Therefore, the operation command generating unit 2022 generates the command (departure command) in order that the first autonomous traveling vehicle 100A is departed from the course of the second autonomous traveling vehicle 100B. This command is transmitted to the first autonomous traveling vehicle 100A by the communication unit 201 (Step S16).

If the departure command, which is transmitted from the server apparatus 200, is received by the first autonomous traveling vehicle 100A, the traveling control unit 1033 of the first autonomous traveling vehicle 100A controls the traveling of the first autonomous traveling vehicle 100A in Step S17 so that the first autonomous traveling vehicle 100A is departed from the course of the second autonomous traveling vehicle 100B. The first autonomous traveling vehicle 100A gives way to the second autonomous traveling vehicle 100B, for example, such that the traveling control unit 1033 allows the first autonomous traveling vehicle 100A to perform the lane change to the lane which is different from the cruising lane of the second autonomous traveling vehicle 100B as indicated in FIG. 3 described above, or the traveling control unit 1033 puts the first autonomous traveling vehicle 100A aside to the road shoulder to temporarily stop as indicated in FIG. 4 described above. Accordingly, it is possible to suppress such a situation that the smooth traveling of the second autonomous traveling vehicle 100B is disturbed by the first autonomous traveling vehicle 100A. As a result, it is possible to allow the first autonomous traveling vehicle 100A and the second autonomous traveling vehicle 100B to travel in accordance with the respective needs.

Note that in the example indicated in FIG. 6, such a case has been described that the first autonomous traveling vehicle 100A gives way to the second autonomous traveling vehicle 100B irrelevant to the relative speed or velocity between the first autonomous traveling vehicle 100A and the second autonomous traveling vehicle 100B. However, it is also allowable that the first autonomous traveling vehicle 100A gives way to the second autonomous traveling vehicle 100B as long as the traveling speed of the second autonomous traveling vehicle 100B is higher than that of the first autonomous traveling vehicle 100A.

Further, in the example indicated in FIG. 6, such a case has been described that the priority of the following second autonomous traveling vehicle 100B is higher than that of the preceding first autonomous traveling vehicle 100A. However, such a case is also assumed that the priority of the following second autonomous traveling vehicle 100B is lower than that of the preceding first autonomous traveling vehicle 100A. In the case of the priorities as described above, if the traveling speed of the second autonomous traveling vehicle 100B is higher than the traveling speed of the first autonomous traveling vehicle 100A, the server apparatus 200 may allow the second autonomous traveling vehicle 100B to follow the first autonomous traveling vehicle 100A by decreasing the traveling speed of the second autonomous traveling vehicle 100B to be equivalent to that of the first autonomous traveling vehicle 100A. Further, if the second autonomous traveling vehicle 100B can pass the first autonomous traveling vehicle 100A without causing the course change of the first autonomous traveling vehicle 100A (for example, if the second autonomous traveling vehicle 100B can pass the first autonomous traveling vehicle 100A by changing the lane to the passing lane in a situation in which the first autonomous traveling vehicle 100A travels on the cruising lane), the server apparatus 200 may control the traveling of the second autonomous traveling vehicle 100B so that the second autonomous traveling vehicle 100B passes the first autonomous traveling vehicle 100A.

According to the embodiment described above, when the plurality of autonomous traveling vehicles 100 travel on the identical lane in the mixed manner, the autonomous traveling vehicle 100 which has the needs such that the traveling quality is regarded as important as compared with the fare or carriage (autonomous traveling vehicle 100 having the high billing charge with respect to the user) can travel preferentially as compared with the autonomous traveling vehicle 100 which has the needs such that the fare or carriage is regarded as important as compared with the traveling quality (autonomous traveling vehicle 100 having the low billing charge with respect to the user). In other words, when the plurality of autonomous traveling vehicles travel on the identical lane in the mixed manner, such a situation is suppressed that the autonomous traveling vehicle having the low priority disturbs the smooth traveling of the autonomous traveling vehicle having the high priority. As a result, the respective autonomous traveling vehicles 100 can travel adequately with respect to the respective needs.

Note that in this embodiment, such a case has been described that the setting process for setting the priority, the generating process for generating the departure command and the like are performed on the side of the server apparatus. However, these processes may be performed on the side of the vehicle. For example, if the environment detecting unit 1032 of the autonomous traveling vehicle 100 detects an other autonomous traveling vehicle which follows the subject vehicle, on the basis of the data acquired by the surrounding situation detection sensor 101, the information (billing charge) concerning the priority of the following autonomous traveling vehicle may be acquired by performing the inter-vehicle communication between the subject vehicle and the following autonomous traveling vehicle by means of the communication unit 105. If the acquired billing charge is higher than the billing charge of the subject vehicle, the following autonomous traveling vehicle may travel preferentially as compared with the subject vehicle.

### Another Embodiment

In the embodiment described above, such a case has been described that the priorities are set among the plurality of autonomous traveling vehicles on the basis of the billing charges for the users of the respective autonomous traveling vehicles. However, the priorities among the plurality of autonomous traveling vehicles may be set on the basis of the traveling speeds of the respective autonomous traveling vehicles. For example, when the plurality of autonomous traveling vehicles travel on the identical lane in the mixed manner, the priority of the autonomous traveling vehicle having the high traveling speed may be set to be higher than that of the autonomous traveling vehicle having the low traveling speed. In this case, such a situation is suppressed that the smooth traveling of the autonomous traveling vehicle having the high traveling speed is disturbed by the autonomous traveling vehicle having the low traveling speed. As a result, when the plurality of autonomous traveling vehicles having the different traveling speeds travel on the identical lane, the plurality of autonomous traveling vehicles can be allowed to travel efficiently.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A traveling control system for autonomous traveling vehicles for controlling the plurality of autonomous traveling vehicles which perform autonomous traveling in accordance with predetermined operation commands, the traveling control system comprising:
a controller comprising at least one processor,
the controller configured to:
set priorities among the plurality of autonomous traveling vehicles; and
control traveling of the plurality of autonomous traveling vehicles so that the autonomous traveling vehicle having a priority set to be high travels preferentially as compared with the autonomous traveling vehicle having the priority set to be low, if the plurality of autonomous traveling vehicles travel on an identical lane in a mixed manner.

2. The traveling control system according to claim 1, wherein the controller sets the high priority for the autonomous traveling vehicle in which a billing charge is high for a user as compared with the autonomous traveling vehicle in which the billing charge is low for the user.

3. The traveling control system according to claim 1, wherein the controller sets the high priority for the autonomous traveling vehicle in which a traveling speed is high as compared with the autonomous traveling vehicle in which the traveling speed is low.

4. A server apparatus for controlling a plurality of autonomous traveling vehicles which perform autonomous traveling in accordance with predetermined operation commands, the server apparatus comprising:
a controller comprising at least one processor, the controller configured to:
set priorities among the plurality of autonomous traveling vehicles; and
provide the operation commands to the plurality of autonomous traveling vehicles so that the autonomous traveling vehicle having a priority set to be high travels preferentially as compared with the autonomous traveling vehicle having the priority set to be low, if the plurality of autonomous traveling vehicles traveling on an identical lane are detected.

5. An autonomous traveling vehicle which performs autonomous traveling in accordance with a predetermined operation command, the autonomous traveling vehicle comprising:
a controller comprising at least one processor,
the controller configured to:
detect an other autonomous traveling vehicle which follows a subject vehicle on the same lane as that of the subject vehicle;
acquire an information concerning a priority of the other autonomous traveling vehicle by making inter-vehicle communication with the other autonomous traveling vehicle, if the other autonomous traveling vehicle is detected; and
control traveling of the subject vehicle so that the other autonomous traveling vehicle travels preferentially as compared with the subject vehicle, if the acquired priority of the other autonomous traveling vehicle is higher than a priority of the subject vehicle.
